(19) United States
(12) Patent Application Publication
(10) Pub. No.: US 2026/0081068 A1
(43) Pub. Date: Mar. 19, 2026

(54) METHOD FOR PREPARATION OF SEVERELY PLASTICALLY DEFORMED PARTICULATES FOR MANGANESE-ALUMINUM-BASED ALLOY PERMANENT MAGNETS

(71) Applicant: UNIVERSITY OF PITTSBURGH-OF THE COMMONWEALTH SYSTEM OF HIGHER EDUCATION, PITTSBURGH, PA (US)

(72) Inventors: JORG M. WIEZOREK, PITTSBURGH, PA (US); RAVI SHANKAR MEENAKSHISUNDARAM, PITTSBURGH, PA (US)

(73) Assignee: UNIVERSITY OF PITTSBURGH-OF THE COMMONWEALTH SYSTEM OF HIGHER EDUCATION, PITTSBURGH, PA (US)

(21) Appl. No.: 18/818,930

(22) Filed: Aug. 29, 2024

Related U.S. Application Data
(60) Provisional application No. 63/580,036, filed on Sep. 1, 2023.

(51) Int. Cl. H01F 41/02; B22F 1/142; B22F 9/04; C22F 1/16

(52) U.S. Cl. CPC H01F 41/0253; B22F 1/142; C22F 1/16; B22F 9/04; B22F 2009/045; B22F 2301/00

(57) ABSTRACT

A method of manufacturing permanent magnet materials for use in making MnAl-based alloy permanent magnets includes providing an ε-phase MnAl-based alloy solid feedstock, end-milling the ε-phase MnAl-based alloy solid feedstock to produce a plurality of severely plastically deformed ε-phase MnAl-based alloy particulates, and creating the permanent magnet materials by thermally processing the plurality of ε-phase MnAl-based alloy particulates to produce a plurality of τ-phase MnAl-based alloy particulates. In addition, the method may further include making a permanent magnet by mixing the τ-phase MnAl-based alloy particulates with a binder to produce a mixture, and forming the mixture into a desired shaped for the permanent magnet. The forming step may include one or more of injection molding the mixture, compression bonding the mixture, calendering the mixture or extruding the mixture.

### CROSS REFERENCE TO RELATED APPLICATIONS

This application claims priority to U.S. Provisional Patent Application Ser. No. 63/580,036, filed on Sep. 1, 2023, and titled “Method for Preparation of Severely Plastically Deformed Particulates for Manganese-Aluminum-Based Alloy Permanent Magnets,” the disclosure of which is incorporated herein by reference.

### STATEMENT OF GOVERNMENT INTEREST

This invention was made with government support under grant #CMMI-1404641 awarded by the NSF (National Science Foundation). The government has certain rights in the invention.

### FIELD OF THE INVENTION

The disclosed concept relates generally to the manufacture of permanent magnets, and, in particular, to a method of manufacturing severely plastically deformed MnAl-based alloy particulates for use in making MnAl-based alloy permanent magnets.

### BACKGROUND OF THE INVENTION

Permanent magnets (PM) are used widely in electric motors and generators, which are critically important components in clean energy technologies, such as hybrid-and all-electric vehicles, and renewable energy generation from wind and water. Currently preferred PM materials for high performance application in motors and generators are based on rare-earth element (REE) containing alloys, e.g., NdFeB, which offer maximal magnetic energy product ((BH)max, up to ≈55 MGOe), while hard ferrites and conventional AlNiCo alloys are utilized for less demanding applications. To diversify the available range of cost-effective PM materials and to improve the resilience of supply chains associated with the anticipated increase in demand from broadening implementation of clean energy technologies, the development of REE-free magnets with (BH)max in the range of ≈8 MGOe to 30 MGOe has been proposed. Enticing candidate materials for this purpose include alloys based on MnAl, Mn—Bi and Mn—Ga. Of these, MnAl offers lowered cost and potential mitigation against geopolitical risks on supply-chains due to abundant sources for both Mn and Al.

MnAl PM alloys owe their attractive magnetic properties to the formation of the thermodynamically metastable tetragonal and chemically ordered τ-phase. The τ-phase exhibits large uniaxial magnetic anisotropy (1.7 MJ/m3) and high saturation magnetization (6.2 kG), leading to potential for a theoretical (BH)max≈12 MGOe. For slightly Mn-rich compositions, e.g., 54 atomic percent (at. %) Mn, the τ-phase forms from the high temperature ε-phase, which is a chemically disordered solid solution with a hexagonal close packed (hcp) structure. This composition-invariant transformation of ε-phase to τ-phase occurs in competition with the transformation of ε-phase to non-ferromagnetic equilibrium phases, the Mn-richer cubic β-Mn solid solution and the Al-richer ordered intermetallic γ₂-phase, Al₈Mn₅, with a rhombohedral structure. The ε-phase can be retained in MnAl alloys at room temperature by quenching into oil or water after solution annealing in the ε-phase field (e.g., 950° C.≤T≤1150° C.) and via rapid solidification in melt-spinning or preparation of powders by gas-atomization. Thermal aging or thermomechanical treatments at temperatures, T, ranging from ≈400° C.≤T≤≈700° C. have been used to obtain the τ-phase in MnAl alloys from the retained ε-phase.

Several different mechanisms for the composition-invariant transformation of ε-phase to τ-phase have been reported. These involve a mode of crystallographic shear combined with local atomic rearrangements by short-circuit diffusion and a “massive” mode facilitated by repeated nucleation and rapid motion of incoherent transformation interface sections where short-circuit diffusion achieves the crystal structure change. Relative to binary composition materials, small additions of C of up to ≈2 at. % have been shown to enhance the resistance of τ-phase against decomposition into the equilibrium β- and γ₂-phases in MnAl—C alloys. It has been shown that bulk processing of MnAl—C containing 0.69 wt. % (≈2 at. %) C via hot extrusion of cast rods and subsequent annealing resulted in textured τ-phase of micrometer scale grain size with a (BH)max≈6.3 MGOe. The state-of-the-art for the experimentally realized maximum energy product, (BH)max, corresponds to about 55% of the theoretically achievable limit. This early research revealed a challenge with developing large coercivity (HC>3 kOe) for bulk forms of MnAl PM alloys. Hence, as summarized in recent reviews, research conducted over the past two decades has focused mainly on improving coercivity of MnAl PM materials. Popular approaches explored ε-phase with nanoscale refined grain size as precursors for controlled fabrication of τ-phase microstructures with sub-micron or nanoscale refined scale and/or containing nanoscale obstacles, such as carbide precipitates, for magnetic domain motion, by subsequent thermal annealing.

Particulate and powder processing schema, as well as severe plastic deformation (SPD) processing via equal-channel-angular-pressing (ECAP) and high-pressure-torsion (HPT) have been utilized to improve coercivity (HC) using submicron/nanometer scale-refined MnAl-base particulate materials. For instance, room temperature coercivity values as high as HC=5.4 kOe have been reported for binary τ-phase based MnAl PM powders obtained via ball milling and subsequent annealing. However, the associated magnetization behaviors of the MnAl PM powders typically exhibited undesirable characteristics, with small magnitudes for saturation, Ms, retained remanent, Mr, magnetization, e.g., Ms≤89 emu/g and Mr≤45 emu/g, and correspondingly low “squareness-ratio,” Mr/Ms≤≈0.5. Since the particulate processing routes using ball milling of powders and melt-spun ribbons have yielded MnAl PM materials with maximum magnetic energy products, (BH)max, that remained inferior to those realized in equivalent composition materials processed via hot-extrusion, more recent research revisited hot-deformation processing routes.

Given the shortcomings of the prior art, there is thus room for improvement in methods of manufacturing MnAl-based alloy particulates for use in making MnAl-based alloy permanent magnets.

### SUMMARY OF THE INVENTION

These needs, and others, are met by a method of manufacturing permanent magnet materials for use in making MnAl-based alloy permanent magnets that includes providing an ε-phase MnAl-based alloy solid feedstock, end-milling the ε-phase MnAl-based alloy solid feedstock to produce a plurality of severely plastically deformed ε-phase MnAl-based alloy particulates, and creating the permanent magnet materials by thermally processing the plurality of ε-phase MnAl-based alloy particulates to produce a plurality of τ-phase MnAl-based alloy particulates. In addition, the method may further include making a permanent magnet by mixing the τ-phase MnAl-based alloy particulates with a binder to produce a mixture, and forming the mixture into a desired shaped for the permanent magnet. The forming step may include one or more of injection molding the mixture, compression bonding the mixture, calendering the mixture or extruding the mixture.

### BRIEF DESCRIPTION OF THE DRAWINGS

A full understanding of the invention can be gained from the following description of the preferred embodiments when read in conjunction with the accompanying drawings in which:

FIG. 1 is a flowchart illustrating a method of manufacturing severely plastically deformed MnAl-based alloy particulates for use in making MnAl-based alloy permanent magnets according to an exemplary embodiment of the disclosed concept;

FIGS. 2A and 2B are backscatter electron (BSE) SEM micrographs of the as-cast and the solutionized and quenched state, respectively, of an Mn₅₄—Al₄₆ alloy according to an exemplary embodiment of the disclosed concept;

FIG. 2C is a zone axis selected area electron diffraction pattern (SAEDP) from an ε-phase grain according to an exemplary embodiment of the disclosed concept;

FIG. 2D is a dark field TEM for the ε-phase grain of FIG. 2C;

FIGS. 2E and 2F are XR patterns and magnetic hysteresis-loops, respectively, for the as-cast state and the solutionized and quenched state of FIGS. 2A and 2B;

FIGS. 3A-3F are SEM micrographs of end-milling derived ε-phase MnAl chip particulates according to an exemplary embodiment of the disclosed concept which illustrate the effect on particulate morphology of various end-milling process parameters;

FIGS. 4A and 4B show XRD diffractometer scans and DSC scans at 40K/minute sweep rate, respectively, illustrating the effects of the spindle/tool rotational speed on the internal structure of the end-milling derived ε-phase Mn—Al particulates according to an exemplary embodiment of the disclosed concept;

FIG. 5A is a schematic representation of the saw tooth morphology of the chip particulates according to an exemplary embodiment of the disclosed concept, and FIG. 5B is an Ion-current induced SE image of the same chip particulate;

FIGS. 5C, 5D, and 5E are Bright field multi-beam TEM micrographs of the ε-phase microstructure of a single saw tooth region of a chip particulate obtained for end-milling at 600 RPM according to an exemplary embodiment of the disclosed concept;

FIG. 5F is an SEM EBSD derived inverse pole figure (IPF) orientation map for the undeformed state ε-phase MnAl according to an exemplary embodiment of the disclosed concept;

FIGS. 5G and 5H are TEM ACOM IPF orientation maps for ε-phase MnAl after end-milling at 600 RPM and 3000 RPM, respectively, according to an exemplary embodiment of the disclosed concept;

FIGS. 6A and 6B are XRD scans and VSM M-H hysteresis loops, respectively, for end-milling derived particulates according to exemplary embodiments of the disclosed concept;

FIGS. 7A and 7B show M-H hysteresis loops for CNC end-milling derived particulates for an exemplary particulate assay according to the disclosed concept;

FIGS. 7C and 7D show tables that summarize key magnetic properties as a function of annealing time for the isothermal annealing treatments of FIGS. 7A and 7B;

FIGS. 8A, 8B, and 8C show multibeam bright field TEM micrographs of the microstructure of CNC end-milling derived particulates according to exemplary embodiments of the disclosed concept; and

FIGS. 8D, 8E, and 8F show a virtual bright field image obtained from a PED scan, an ACOM IPF orientation map with phase specific orientation legend shown, and an associated ACOM phase map for ε-phase (8.5% area fraction) and τ-phase (91.5% area fraction), respectively, for an exemplary embodiment of the disclosed concept.

### DETAILED DESCRIPTION OF THE INVENTION

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, “directly coupled” means that two elements are directly in contact with each other.

As used herein, the term “number” shall mean one or an integer greater than one (i.e., a plurality).

As used herein, the term “self-similar morphology” shall mean a shape or object that can be divided into parts that are similar to the whole, and may include any of the following: flakes, ribbons, strips, serrated chips, polygonal or irregular objects.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the disclosed concept. It will be evident, however, that the disclosed concept can be practiced without these specific details without departing from the spirit and scope of the disclosed concept.

The disclosed concept, as described herein, employs end-milling as a plastic-deformation process for the preparation of severe plastic deformation (SPD) processed MnAl-based alloy materials with a sub-micron (<1 μm) to nanometer scale (≤100 nm) grain size in the refined microstructure. According to the disclosed concept, the MnAl-based alloy materials may include: (i) binary ε-phase MnAl alloy materials, and/or (ii) micro-alloyed ε-phase MnAl—X alloy materials, where X represents one or more micro-alloying elements at concentrations smaller than 3 atomic (molar) percent, giving (MnAl)₉₇—X₃, where the numerals represent atomic percent. Within the fraction of Mn plus Al of the either binary or micro alloyed materials, the composition is 54 atomic % Mn and 46 atomic% Al. The microstructures of these materials constitute self-similar morphologies within particulates of micrometer scale external dimensions. These structures are harnessed as feedstocks to obtain τ-phase MnAl-based alloy materials via subsequent annealing and/or thermomechanical processing. The ultimate objective is their utilization as microstructure engineered materials with enhanced properties for PM applications, such as, without limitation, bonded permanent magnets. The cutting operations associated with end-milling according to the disclosed concept offer single-pass deformation processing configurations for room temperature SPD of metals and alloys at high straining rates. The associated deformation paths of the disclosed concept exhibit similarities to ECAP, foster formation of material specific deformation textures, impart a large amount of plastic strain (even to materials that typically suffer from a lack of room temperature ductility), and induce dynamic recrystallization phenomena. The disclosed concept, in the exemplary embodiment, focuses on applying end-milling to a binary ε-phase MnAl-based alloy, such as an MnAl alloy, or a micro-alloyed MnAl—X alloy. The effects of the principal machining process parameters of the end-milling, such as the tool spindle rotational speed and the axial and radial depth of the cut, on the external shape and internal microstructure of the ε-phase MnAl-based alloy chip particulates and the evolution of the microstructure and associated magnetic properties in response to subsequent isothermal annealing have been determined to be advantageous. Thus, the end-milling process of the disclosed concept may be used to establish SPD'd ε-phase MnAl-based alloy particulates that are characterized by sub-micron to nanometer scale refined microstructures that are suitable for preparation of τ-phase based MnAl-based alloy PM particulates with enhanced PM properties via subsequent thermal annealing. The present inventors have combined structural characterization by X-ray diffraction (XRD) and scanning and transmission electron microscopy (SEM and TEM) with thermal analysis by differential scanning calorimetry (DSC) and room temperature magnetic property measurements using a vibrating sample magnetometer (VSM) to confirm that advantageous properties of the materials manufactured according to the disclosed concept.

Thus, according to the disclosed concept, end-milling is used as a processing route for the effective preparation of ε-phase MnAl-based alloy particulates with micron scale external dimensions and self-similar shapes from binary as-cast feedstock with a composition of 54 at. % Mn and 46 at. % Al in the exemplary embodiment. Thus, the effects of operational process parameter combinations of end-milling as a single-pass plastic deformation process according to the disclosed concept have been identified to permit the genesis of morphologically self-similar particulates with micrometer scale dimensions. The end-milling process establishes an ε-phase that is characterized by cold-worked and sub-micron to nanometer scale refined microstructures. In addition, the end-milling derived MnAl-based alloy particulates are suitable for the preparation of a τ-phase containing MnAl-based alloy PM particulates with enhanced PM properties via isothermal annealing. Discernibly higher rates for the exothermic ε-phase decomposition reactions in the end-milling derived particulates have been observed for isothermal annealing at temperatures in the range of 673 K≤T≤723 K. In the exemplary embodiment, large saturation magnetization and coercivity in combination with good squareness ratios of the magnetization curves resulted in a (BH)max=4.2 MGOe for the end-milling derived binary Mn₅₄Al₄₆-based alloy particulates obtained for the highest rotational tool speed of 4200 RPM after annealing for 20 min at 673K. Furthermore, the disclosed concept, in comparison with particulate/powder processing routes that use ball milling, exploits the cutting processes of automated machining operations and reduces the number of processing steps required in schema for the preparation of MnAl PM from particulate precursor materials.

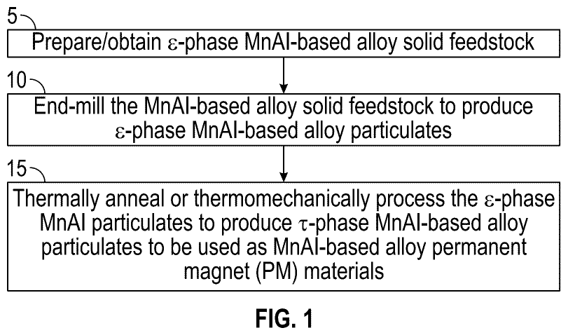

FIG. 1 is a flowchart illustrating a method of manufacturing severely plastically deformed MnAl-based alloy particulates for use in making MnAl-based alloy permanent magnets according to an exemplary embodiment of the disclosed concept. The method begins at step 5, wherein an ε-phase MnAl-based alloy solid feedstock is obtained or prepared, the latter by, for example a casting process. Particular non-limiting examples of how to prepare such a feedstock are described elsewhere herein. Next, at step 10, the ε-phase MnAl-based alloy solid feedstock is end-milled, preferably, although not necessarily, in a single pass, to produce ε-phase MnAl-based alloy particulates. As described herein, the end-milling subjects the material to SPD, such that the resulting ε-phase MnAl-based alloy particulates are severely plastically deformed, yielding the characteristics described elsewhere herein. Then, at step 15, the ε-phase MnAl-based alloy particulates are thermally annealed or thermomechanically processed to produce τ-phase MnAl-based alloy particulates. Such τ-phase MnAl-based alloy particulates may then be used as a feedstock to produce permanent magnets. For example, the τ-phase MnAl-based alloy particulates may be used to make bonded permanent magnets by mixing the τ-phase MnAl-based alloy particulates with a binder and forming the mixture into a desired shaped using a process such as, without limitation, injection molding, compression bonding, calendering or extrusion.

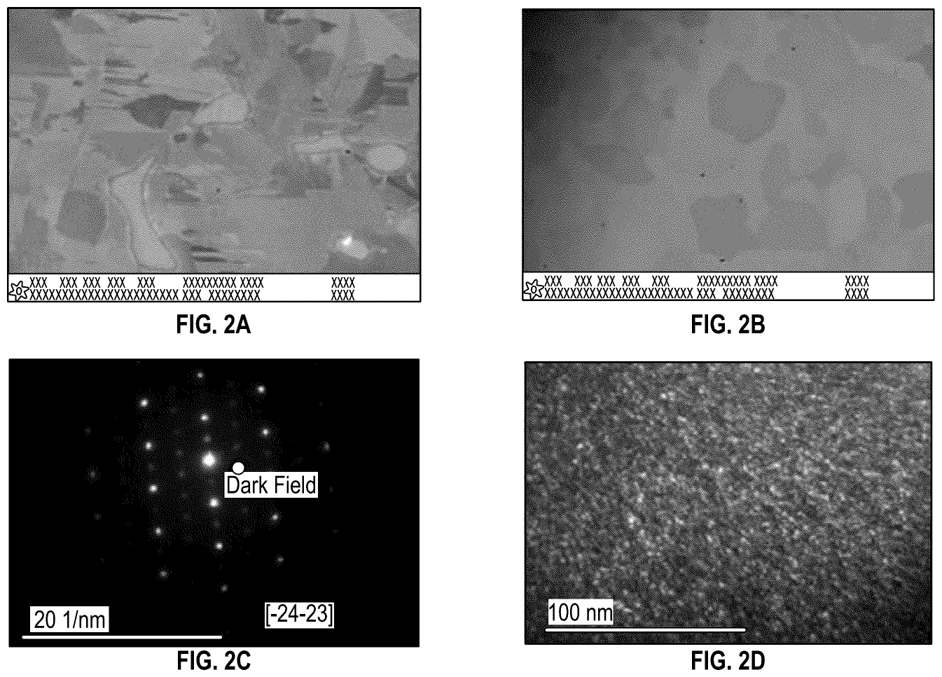

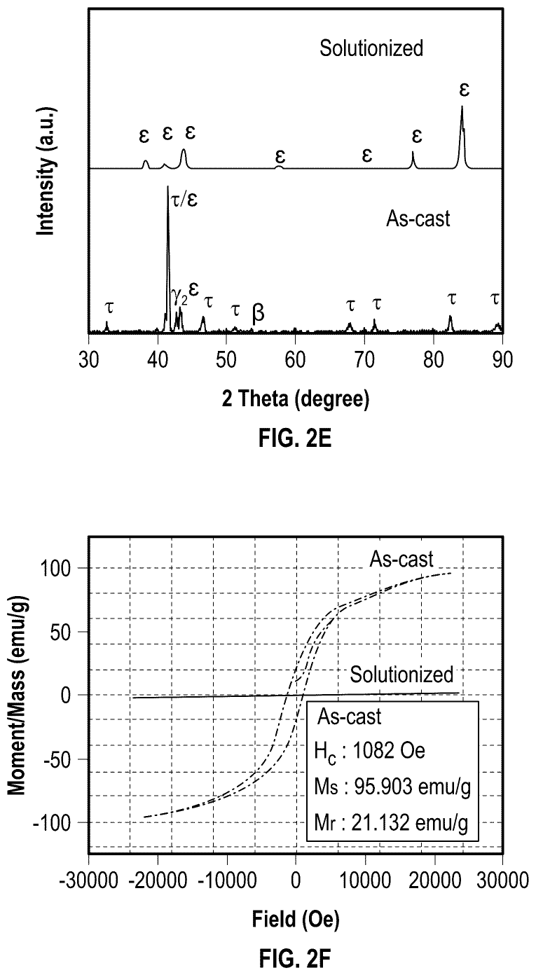

In one particular, non-limiting exemplary embodiment, the method of FIG. 1 may be performed as follows. First, a bulk MnAl alloy feedstock is prepared via vacuum induction melting of elemental metal Mn and Al with purity of 99.95% and subsequent casting into 2.54 cm (1 inch) diameter, ˜45.7 cm (18 inches) long cylindrical rod shapes with a target composition of Mn₅₄Al₄₆. The composition of the bulk alloy feedstock may be verified by X-ray fluorescence analysis for the external surface, and by energy-dispersive X-ray spectroscopy (EDS) in an SEM instrument operated at 20 kV (e.g., JEOL JSM 6610LV and Oxford EDS) for cross-sections of the cast rods. The as-cast MnAl rods are then sectioned into smaller pieces about 12 mm (0.5 inch) thick using a high-speed precision saw (e.g., Struers Accutom 50) and then heat treated for solutionizing at 1323 K (1050° C.) for 2 hours under an argon atmosphere using a three-zone tube furnace (Lindberg Model 54347, 1200° C. max) followed by water quenching to obtain ε-phase Mn₅₄Al₄₆ alloy. Phase identification and microstructure analysis after the solutionizing heat treatment may be performed by XRD, TEM and SEM. FIGS. 2A and 2B are backscatter electron (BSE) SEM micrographs of the as-cast and the solutionized and quenched state, respectively, of an Mn₅₄—Al₄₆ alloy according to an exemplary embodiment of the disclosed concept. FIG. 2C is a zone axis selected area electron diffraction pattern (SAEDP) from an ε-phase grain according to an exemplary embodiment of the disclosed concept where the diffracted beam selected for formation of the dark field TEM micrograph shown in FIG. 2D is marked as ‘Dark Field’ by a circle. FIG. 2D is a dark field TEM for the ε-phase grain. FIGS. 2E and 2F are XR patterns and magnetic hysteresis-loops, respectively, for the as-cast state and the solutionized and quenched state.

In this embodiment, the end-milling may be performed using either or both of a manually operated milling machine (e.g., Bridgeport Series I Standard Mill) or a computer numerically controlled (CNC) milling machine (e.g., Haas TM1-P 4-Axis CNC milling machine) equipped with two end-milling tools (e.g., Seco MEGA-64 4 fluted chamfer end mill and the Promax Tools 3 flute fine tooth roughing end mill). The machined particulates may be collected and characterized by SEM imaging primarily to determine external morphology and scale. XRD may be performed with Cu-K-alpha wavelength using diffractometer instruments in the symmetric Bragg-Brentano geometry (e.g., Malvern Analytical/Panalytical Emperyan, and Bruker Discovery D8) for studies of the internal structure of the machined particulates with a focus on phase identification and crystallite size via peak shape analysis using the Scherrer formula. Thermal analysis may be performed with a differential scanning calorimeter (DSC, PerkinElmer DSC 7) over the temperature range of 323 K (50° C.) to 873 (600° C.) using constant heating and cooling rates of 40 K/min under ultra-pure Ar gas flow for sample mass ranging from 5 mg to 15 mg. Isothermal annealing treatments of the particulate materials obtained via end-milling are, in this embodiment, performed under high-vacuum using an optical furnace of a rapid annealing system (ULVAC-RIKO MILA-3000) with 10 K/s heating rate and subsequent isothermal annealing holds at 623 K, 673 K, 698 K, and 723 K, respectively, for durations of 300 s=5 min, 600 s=10 min and 1200 s=20 min for each isotherm temperature, followed by furnace cooling. The magnetic properties of the resulting τ-phase particulates may be determined from magnetic hysteresis loops performed at room temperature with a vibrating sample magnetometer (e.g., VSM, Lakeshore 7400) with a maximum externally applied field of either 1.5 T or 2.2 T. Moreover, detailed locally resolved microstructural studies may be performed by SEM (e.g., ThermoFisher Scientific Apreo FEGSEM and ThermoFisher Scientific Scios Dual-Beam FIB/SEM, operated at 20 kV) and by TEM (e.g., Jeol JEM2100FX and a ThermoFisher Scientific Tecnai G2 F20 UT, operated at 200 kV). Elemental composition analyses may be performed via energy-dispersive X-ray spectroscopy (EDS) in the SEM and TEM. SEM based crystal orientation and phase maps may be acquired by electron beam backscatter diffraction (EBSD). With a focus on phase identification and grain size determination, automated crystal orientation mapping (ACOM) in TEM via scanned acquisition of maps of precession electron diffraction patterns (NanoMegas ASTAR, Topspin) may be performed for precession half-angles of 0.5° C. to 0.7° C., nominally 3 nm beam size and 3 nm scanning step size. SEM and TEM samples of the particulates obtained by end-milling may be prepared by use of double-sided sticky carbon tape, embedding in Pb—Sn—Ag solder, and selective extraction of thin lamellae by Dual-beam FIB lift-out with Ga-ions, as needed. During lift-out, sample preparation of the FIB instrument (e.g., ThermoFisher Scientific Scios) may be operated initially at 30 kV, and for the final thinning steps at 5 kV and 2 kV. Prior to TEM studies, the FIB lift-out sample surfaces may be cleaned-up further by scanned low-energy concentrated Ar-ion-beam thinning at 800 eV using a Fischione Model 1040 NanoMill to remove and reduce ion-beam damaged surface layers.

In various additional exemplary embodiments, the end-milling process parameters may use stage speeds ranging from 1 mm/s to 13 mm/s, radial depths of cut, r_{c}, ranging from 0.05 mm to 0.5 mm, axial depths of cut, a_{c}, ranging from 0.1 mm to 0.2 mm, and spindle/tool rotational speeds in the range of 100 rotations per minute (RPM) to 3000 RPM for manual end-milling and 750 RPM to 4200 RPM for CNC end-milling. The combinations of high stage speeds, ≥10 mm/s, with high rotational spindle/tool speeds, ≥600 RPM, and small radial depth of cut, rc≤0.1 mm, may be most effective in obtaining plastically deformed micrometer scale chip particulates.

In addition, in certain additional exemplary embodiments, the particulates are characterized by a “saw-tooth-like” appearance at the free surface (surface not in contact with the cutting tool), with significant serrations or extrusions and cracks aligned approximately perpendicular to the chip material flow direction. The serrated “saw-tooth” morphology is evidence of shear localization. Also, increasing the rotational tool speed increases the fraction of plastically deformed chip particulates while reducing the fraction of undeformed blocky fracture products. Fractured blocky particulates may be virtually eliminated for rotational tool speeds of 3000 RPM using a 13 mm/s stage speed and constant radial depths of cut r_{c} of 0.05 mm and constant axial depths of cut ac of 0.1 mm.

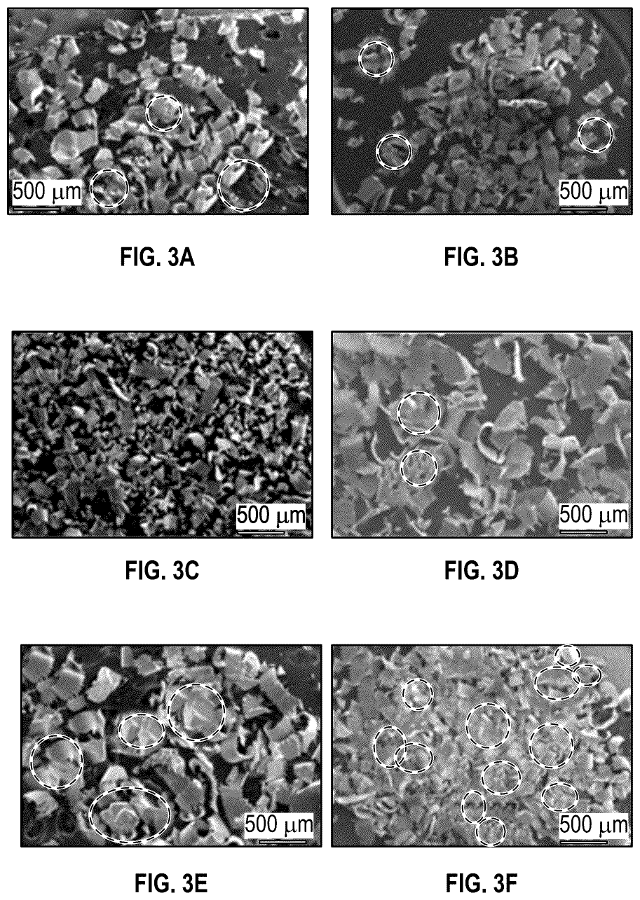

FIGS. 3A-3F are SEM micrographs of end-milling derived ε-phase MnAl chip particulates according to an exemplary embodiment of the disclosed concept which illustrate the effect on particulate morphology of various end-milling process parameters. Specifically, FIG. 3A shows ε-phase MnAl chip particulates made with a tool spindle speed of 600 RPM at constant stage speed of 13 mm/s, FIG. 3B shows ε-phase MnAl chip particulates made with a tool spindle speed of 1500 RPM at constant stage speed of 13 mm/s, FIG. 3C shows ε-phase MnAl chip particulates made with a tool spindle speed of 3000 RPM at constant stage speed of 13 mm/s for constant rc=0.05 mm and ac=0.1 mm, and FIGS. 3D-3F show ε-phase MnAl chip particulates made with rc=0.05 mm, 0.2 mm and 0.5 mm, respectively, for constant axial depth of cut, ac=0.1 mm, and tool spindle speed of 600 RPM. Examples of fractured blocky morphology particles are encircled by dashed lines in these images.

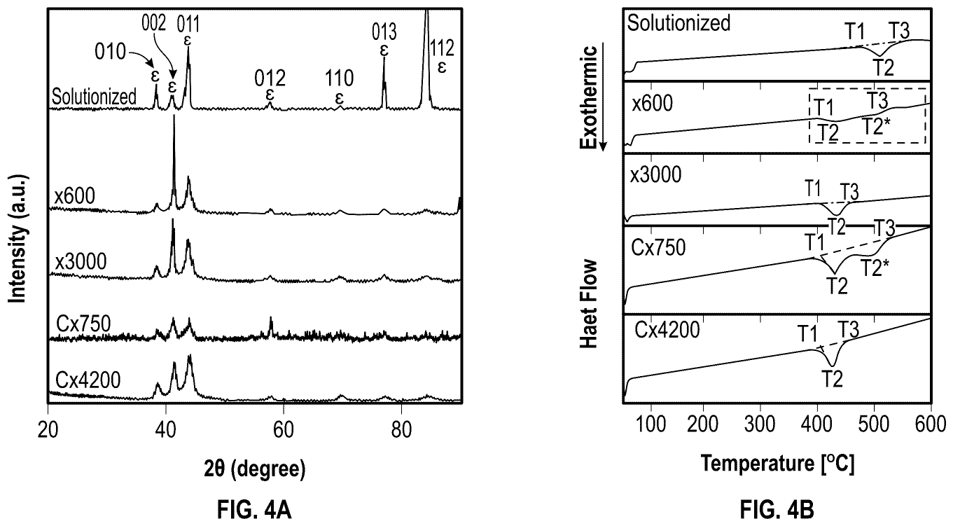

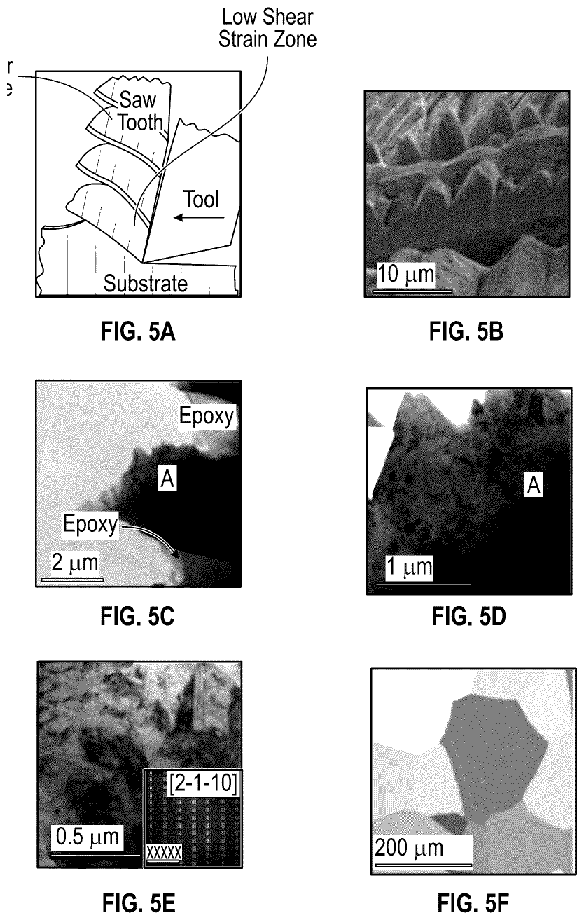

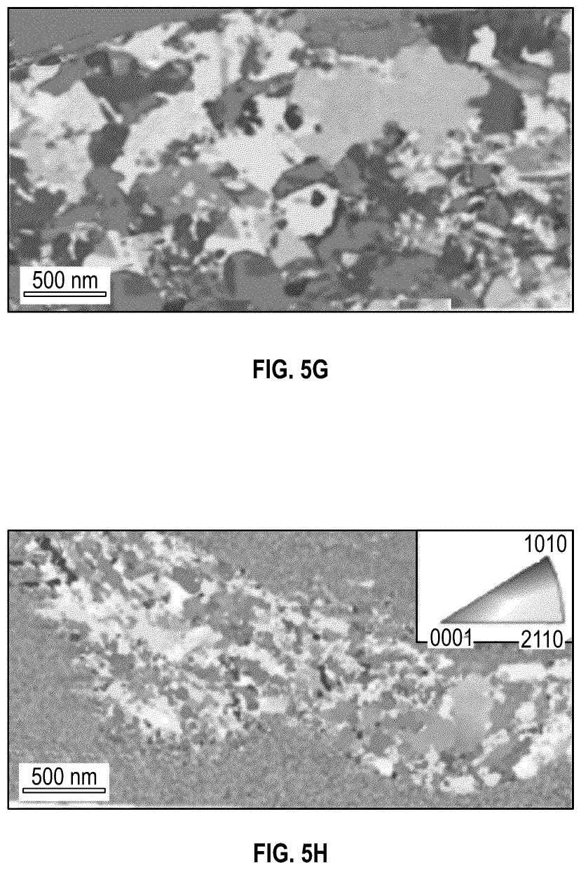

FIGS. 4A and 4B show XRD diffractometer scans and DSC scans at 40K/minute sweep rate, respectively, illustrating the effects of the spindle/tool rotational speed on the internal structure of the end-milling derived ε-phase Mn—Al particulates according to an exemplary embodiment of the disclosed concept. FIG. 5A is a schematic representation of the saw tooth morphology of the chip particulates according to an exemplary embodiment of the disclosed concept as described herein, and FIG. 5B is an Ion-current induced SE image of the same chip particulate. FIGS. 5C, 5D, and 5E are Bright field multi-beam TEM micrographs of the ε-phase microstructure of a single saw tooth region of a chip particulate obtained for end-milling at 600 RPM. Labels A in FIGS. 5C and 5D mark the same location, and FIG. 5E shows a region located just above the label A in FIG. 5D. The selected area diffraction pattern inset in FIG. 5E has been obtained from the central dark contrast grain in FIG. 5E and consistent with a [2-110] zone axis for ε-phase. FIG. 5F is an SEM EBSD derived inverse pole figure (IPF) orientation map for the undeformed state ε-phase MnAl according to an exemplary embodiment of the disclosed concept. FIGS. 5G and 5H are TEM ACOM IPF orientation maps for ε-phase MnAl after end-milling at 600 RPM and 3000 RPM, respectively.

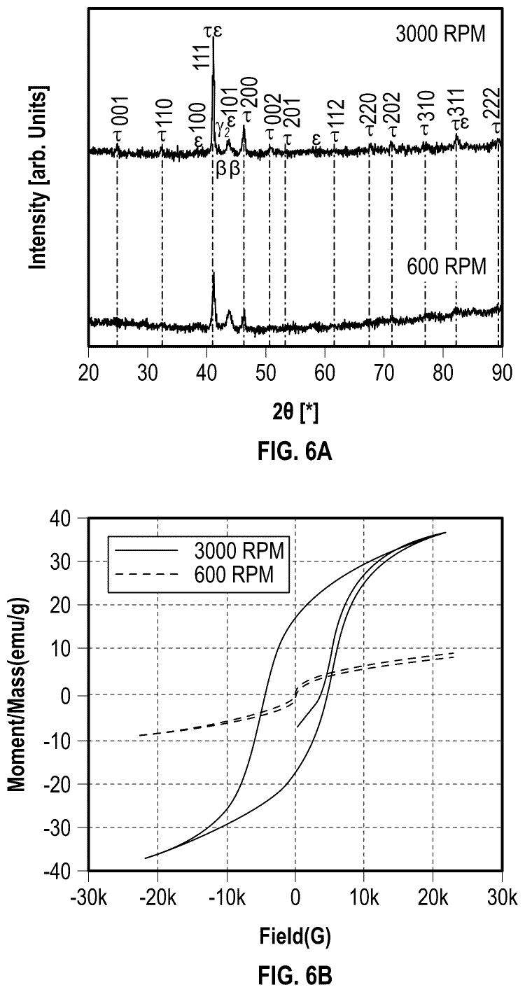

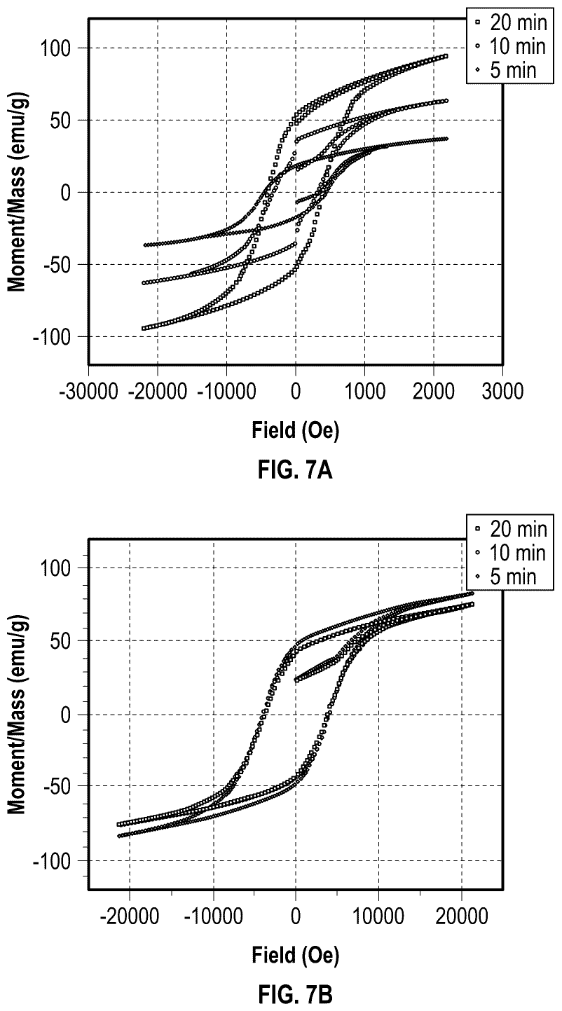

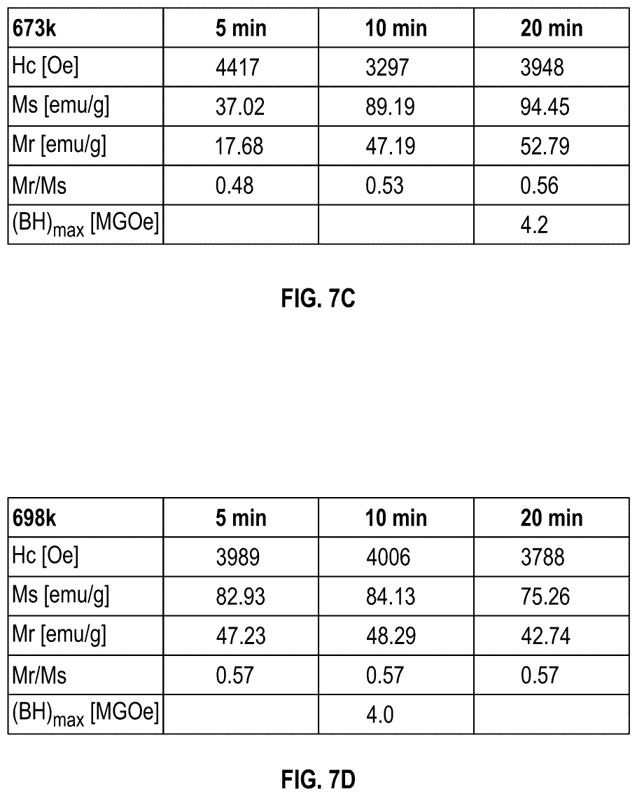

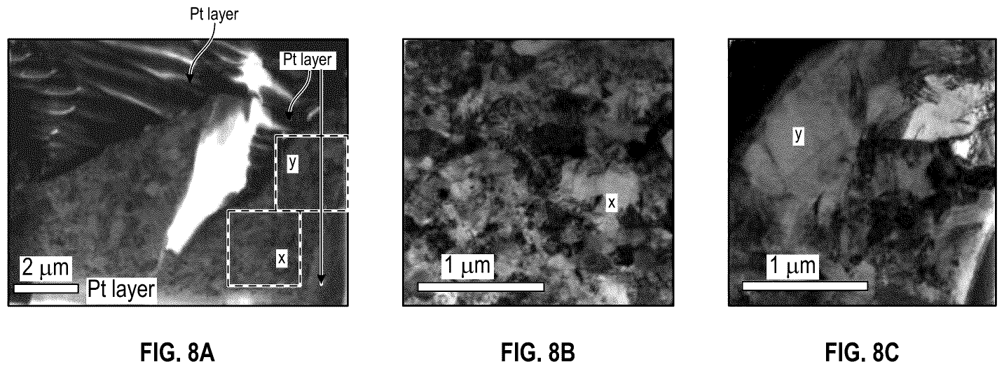

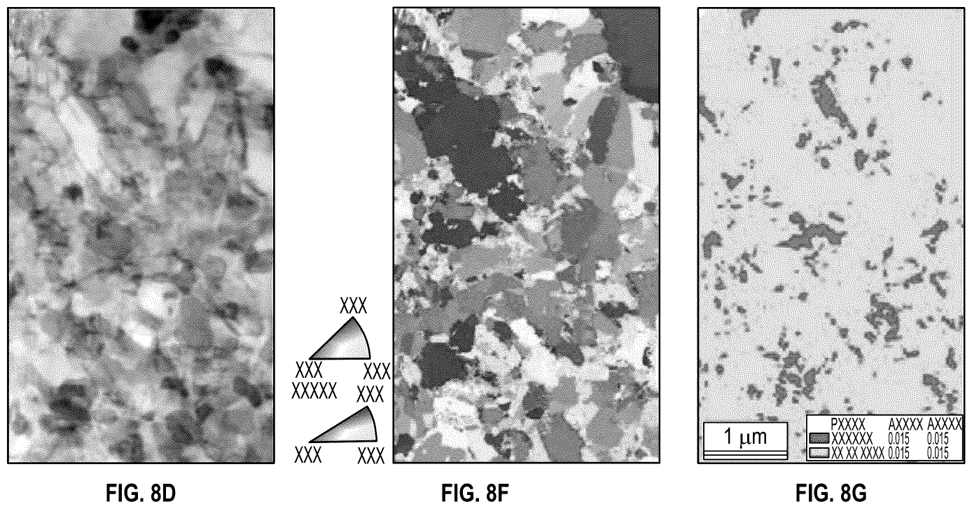

FIGS. 6A and 6B are XRD scans and VSM M-H hysteresis loops, respectively, for end-milling derived particulates using low rotational tool speed of 600 RPM and high rotational tool speed of 3000 RPM, for an exemplary particulate assay after isothermal annealing at 673 K=400° C. for 20 minutes. FIGS. 7A and 7B show M-H hysteresis loops for CNC end-milling derived particulates for an exemplary particulate assay using rotational tool speed of 4200 RPM, after isothermal annealing at temperatures of 400° C.=673 K and 425° C.=698 K, respectively. FIGS. 7C and 7D show tables that summarize key magnetic properties as a function of annealing time for the isothermal annealing treatments of FIGS. 7A and 7B, respectively. FIGS. 8A, 8B, and 8C show multibeam bright field TEM micrographs of the microstructure of CNC end-milling derived particulates using a rotational tool speed of 4200 RPM for an exemplary particulate assay of the disclosed concept after isothermal annealing at 400° C.=673 K for 20 min. FIGS. 8D, 8E, and 8F show a virtual bright field image obtained from a PED scan, an ACOM IPF orientation map with phase specific orientation legend shown, and an associated ACOM phase map for ε-phase (8.5% area fraction) and τ-phase (91.5% area fraction), respectively, for an exemplary embodiment of the disclosed concept.

Thus, the disclosed concept provides end-milling as a machining process that can be used for the effective manufacturing of grain scale refined and severely plastically deformed ε-phase MnAl-based alloy particulates. These particulates can serve as precursors for the fabrication of τ-phase MnAl-based alloy materials that are suitable for developing competitive and perhaps superior permanent magnet performance and properties. Furthermore, in comparison with other particulate/powder processing routes of the prior art, the exploitation of the thermomechanical processes of cutting processes of the end-milling used in the disclosed concept can eliminate at least two processing steps. For example, the crushing of cast ingot material and subsequent the ball-milling of the prior art are not required. Accordingly, the end=-milling machining-based preparation of nanostructured ε-phase particulates of the disclosed concept offers potential for more energy- and cost-effective manufacturing of τ-phase based MnAl PMs.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A method of manufacturing permanent magnet materials for use in making MnAl-based alloy permanent magnets, comprising:
providing an ε-phase MnAl-based alloy solid feedstock;
end-milling the ε-phase MnAl-based alloy solid feedstock to produce a plurality of severely plastically deformed ε-phase MnAl-based alloy particulates; and
creating the permanent magnet materials by thermally processing the plurality of ε-phase MnAl-based alloy particulates to produce a plurality of τ-phase MnAl-based alloy particulates.

2. The method according to claim 1, wherein the plurality of ε-phase MnAl-based alloy particulates have a refined microstructure having a sub-micron (<1 μm) to nanometer scale (≤100 nm) grain size.

3. The method according to claim 2, wherein the microstructure comprises a self-similar morphology.

4. The method according to claim 1, wherein the ε-phase MnAl-based alloy solid feedstock is a binary ε-phase MnAl alloy solid feedstock, wherein the ε-phase MnAl-based alloy particulates are ε-phase MnAl alloy particulates, and wherein the τ-phase MnAl-based alloy particulates are τ-phase MnAl alloy particulates.

5. The method according to claim 1, wherein the ε-phase MnAl-based alloy solid feedstock is a micro-alloyed ε-phase MnAl—X alloy solid feedstock, where X represents one or more micro-alloying elements, wherein the ε-phase MnAl-based alloy particulates are micro-alloyed ε-phase MnAl-X alloy particulates, and wherein the τ-phase MnAl-based alloy particulates are micro-alloyed τ-phase MnAl—X alloy particulates.

6. The method according to claim 5, where X represents one or more micro-alloying elements at concentrations smaller than 3 atomic (molar) percent.

7. The method according to claim 1, wherein the end milling is performed at room temperature.

8. The method according to claim 1, wherein the ε-phase MnAl-based alloy solid feedstock has a composition of 54 at. % Mn and 46 at. % Al.

9. The method according to claim 1, wherein the thermally processing comprises thermal annealing.

10. The method according to claim 9, wherein the thermal annealing comprises isothermal annealing at temperatures ranging from 673 K to 723 K.

11. The method according to claim 9, wherein the thermal annealing is performed under vacuum.

12. The method according to claim 11, wherein the thermal annealing is performed under vacuum with a 10 K/s heating rate and subsequent isothermal annealing holds at 623 K, 673 K, 698 K, and 723 K.

13. The method according to claim 9, wherein the end milling is performed with a tool speed of 4200 RPM and wherein the thermal annealing comprises annealing for 20 min at 673K.

14. The method according to claim 1, wherein the end milling is performed with stage speeds ranging from 1 mm/s to 13 mm/s, radial depths of cut, r_{c}, ranging from 0.05 mm to 0.5 mm, axial depths of cut, a_{c}, ranging from 0.1 mm to 0.2 mm, and spindle/tool rotational speeds in the range of 100 rotations per minute (RPM) to 3000 RPM for manual end-milling and 750 RPM to 4200 RPM for CNC end-milling.

15. The method according to claim 14, wherein the stage speeds are ≥10 mm/s, the rotational spindle/tool speeds are ≥600 RPM, and the radial depth of cut, rc is ≤0.1 mm.

16. The method according to claim 14, wherein the end milling is performed with a rotational tool speed of 3000 RPM using a 13 mm/s stage speed and constant radial depths of cut of 0.05 mm and constant axial depths of cut of 0.1 mm.

17. The method according to claim 1, wherein the end milling is performed with a fluted chamfer end mill cutting tool.

18. The method according to claim 1, wherein the end milling is performed with a flute fine tooth roughing end mill cutting tool.

19. The method according to claim 1, wherein the ε-phase MnAl-based alloy particulates have a saw-tooth-like appearance at a free surface thereof not in contact with a cutting tool used in the end-milling.

20. The method according to claim 1, wherein the providing the ε-phase MnAl-based alloy solid feedstock comprises vacuum induction melting of elemental metal Mn and Al followed by casting into a number of cylindrical rods with a target composition of Mn₅₄Al₄₆.

21. The method according to claim 20, wherein the providing the ε-phase MnAl-based alloy solid feedstock further comprises sectioning the rods into a number of sectioned pieces and solutionizing the number of sectioned pieces to produce the ε-phase MnAl alloy solid feedstock.

22. The method according to claim 21, wherein the solutionizing comprises heat treating the sectioned pieces.

23. The method according to claim 22, wherein the solutionizing comprises heat treating the sectioned pieces under an argon atmosphere.

24. The method according to claim 22, wherein the solutionizing comprises heat treating the sectioned pieces at 1323 K (1050° C.).

25. The method according to claim 24, wherein the solutionizing comprises heat treating the sectioned pieces at 1323 K (1050° C.) for 2 hours.

26. The method according to claim 22, wherein the solutionizing comprises heat treating the sectioned pieces followed by water quenching.

27. The method according to claim 19, wherein the vacuum induction melting of elemental metal Mn and Al is done with a purity of 99.95%.

28. The method according to claim 1, wherein the end-milling the ε-phase MnAl-based alloy solid feedstock to produce the plurality of severely plastically deformed ε-phase MnAl-based alloy particulates is done in a single end milling pass.

29. A method of making a permanent magnet, comprising:
making permanent magnet materials according to claim 1 including the τ-phase MnAl-based alloy particulates;
mixing the τ-phase MnAl-based alloy particulates with a binder to produce a mixture; and
forming the mixture into a desired shaped for the permanent magnet.

30. The method according to claim 29, wherein the forming includes one or more of injection molding the mixture, compression bonding the mixture, calendering the mixture or extruding the mixture.
